(19) United States
(12) Patent Application Publication
(10) Pub. No.: US 2019/0150400 A1
(43) Pub. Date: May 23, 2019

(54) SLIDING AND STACKING PORTABLE RAMP

(71) Applicants: Sudesh Kumar, Durham, CT (US); Vikas Singh, Durham, CT (US)

(72) Inventors: Sudesh Kumar, Durham, CT (US); Vikas Singh, Durham, CT (US)

(21) Appl. No.: 15/934,282

(22) Filed: Mar. 23, 2018

Related U.S. Application Data
(60) Provisional application No. 62/588,386, filed on Nov. 19, 2017.

(51) Int. Cl. A01K 1/035; B65G 69/30; A01K 1/02

(52) U.S. Cl. CPC A01K 1/035; E04F 2011/005; A01K 1/0272; B65G 69/30

(57) ABSTRACT

An apparatus for facilitating animal or vehicle movement between different surface elevations includes multiple floor panel members, including a first floor panel member and a last floor panel member. Each of the floor panel members are slidably attached to an adjacent one of the floor panel members. The floor panel members, when extended, form a ramp having a length which is variable, the floor panel members being adapted to nest within one another when retracted. The apparatus further includes a housing configured to enclose the floor panel members when retracted. The last floor panel member is coupled to the housing in a manner which enables the ramp to be slidably removed from the housing without having the ramp disengage from the housing. The housing includes a front panel removably attached to the housing for securing the floor panel members within the housing when the ramp is retracted.

### CROSS-REFERENCE TO RELATED APPLICATIONS

This application claims the benefit of U.S. Provisional Patent Application Ser. No. 62/588,386, filed Nov. 19, 2017, entitled “SLIDING AND STACKING PORTABLE BOX PET RAMP,” which is hereby incorporated by reference herein in its entirety for all purposes.

### FIELD OF THE INVENTION

The present invention relates generally to ramps for movement of animals to different surface elevations, and, more particularly, to a sliding and stacking portable pet or vehicle ramp.

### BACKGROUND OF THE INVENTION

Pet ownership and pet population in the United States has been growing steadily over the last several years. According to American Pet Products Association's (APPA) 2017-2018 National Pet Owner's Survey, 84.6 million (68 percent) of U.S. households own 89.7 million dogs and 95.6 million cats, respectively. An average U.S. household owns dogs for 18 years and cats for 19 years, respectively (APPA).

Unfortunately, there are many factors which can make it difficult for animals to maneuver from place to place, particularly when moving between different surface elevations, such as, but not limited to, getting into and out of a vehicle for travel, climbing onto or off a bed, or ascending or descending stairs. For instance, there is a pet obesity epidemic in the United States, where 56 percent of dogs and 54 percent of cats are currently classified as obese, according to APPA 2017. Additionally, due at least in part to improved veterinary medical care, more and more pets are living longer, resulting in a growing population of geriatric pets. Owners with obese, geriatric or disabled pets are often forced to lift or move their pets around, or otherwise may require a step or ramp as an aid to allow their pets to traverse between different surface elevations.

Different types of ramps are currently available for pet use, for example fixed (straight) ramps, folding ramps, telescoping ramps, folding pet ramps that can become steps, and fixed pet steps. However, most of these ramps and steps have several disadvantages, including being large, cumbersome, heavy, difficult to carry, requiring assembly and disassembly, and occupying substantial space. These ramps typically have a fixed length and are therefore not suitable for use in confined spaces. Pet steps/stairs are generally not useful for obese and geriatric pets, as it is ergonomically difficult for such pets to climb up or down the steps. Furthermore, since most of these conventional ramps have a fixed length, they do not provide an optimal slope for the pet to easily climb onto an elevated surface (e.g., a vehicle, bed etc.).

### SUMMARY OF THE INVENTION

The present invention, in one or more embodiments, provides an improved pet ramp that is lightweight, portable, compact, and adjustable to infinite combinations of lengths (up to a maximum overall length of the ramp) and angles of incline.

An exemplary apparatus for facilitating animal or vehicle movement between different surface elevations, according to an aspect of the invention, includes a plurality of floor panel members including at least a first floor panel member and a last floor panel member. Each of the floor panel members are slidably attached to an adjacent one of the floor panel members. The floor panel members, when extended, form a ramp having a length which is variable up to maximum overall length of the apparatus. The floor panel members are adapted to nest within one another when retracted. The apparatus further includes a housing defining an interior space configured to enclose the floor panel members when the floor panel members are retracted. The last floor panel member is operatively coupled to the housing in a manner which enables the ramp to be slidably removed from a front opening of the housing without having the last floor panel member disengage from the housing, the last floor panel member being configured to provide an adjustable angle of the ramp in relation to the front opening of the housing. The housing including a front panel removably attached to the housing and pivotally attached to the first floor panel member. The front panel facilitates extension of the floor panel members to form the ramp, the front panel being configured to secure the plurality of floor panel members within the interior space of the housing when the ramp is retracted.

In accordance with another aspect of the invention, a method for facilitating animal or vehicle movement between different surface elevations is provided which includes obtaining a sliding and stacking portable ramp according to an embodiment of the invention, placing the portable ramp on a first surface, pulling the front panel of the housing to extend the plurality of floor panel members to thereby form the ramp, and placing the front panel on a second surface, the second surface being different in elevation relative to the first surface.

As used herein, “facilitating” an action includes performing the action, making the action easier, helping to carry the action out, or causing the action to be performed. For the avoidance of doubt, where an actor facilitates an action by other than performing the action, the action is nevertheless performed by some entity or combination of entities.

Various units, components, or other apparatus may be described herein as being “configured to” perform a particular task or tasks. In such contexts, the term “configured to” is intended to be construed broadly as a recitation of structure generally meaning “having hardware components that” perform the task or tasks during operation. Similarly, various units, components, or other apparatus may be described as performing a task or tasks, for convenience in the description. Such descriptions should be interpreted as including the phrase “configured to.” Reciting a unit, component, or apparatus that is configured to perform one or more tasks is expressly intended not to invoke a 35 U.S.C. § 112, paragraph (f) interpretation for that unit, component, or apparatus.

Aspects of the present invention can provide substantial beneficial technical effects. For example, one or more embodiments of the invention achieve a ramp providing one or more of:
facilitating the transport of animals, vehicles or equipment, the ramp being adjustable to infinite combinations of lengths (up to a maximum length of the ramp) and angles of incline;
compact and portable, and being adapted for easy carrying;
being configured to retract inside its own protective housing;
an easy and intuitive set up and take down procedure.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A is a perspective view of an exemplary sliding and stacking portable ramp shown in a closed, compact box form, according to an embodiment of the present invention;

FIG. 1B is a view of the exemplary ramp shown in FIG. 1A having a recessed handle, according to an embodiment of the present invention;

FIG. 2 is a perspective aerial view of the exemplary sliding and stacking portable pet ramp shown in FIG. 1A in an extended position operated from an elevated surface, according to an embodiment of the present invention;

FIG. 3A is a right-side cross-sectional view of the exemplary sliding and stacking portable pet ramp of FIG. 1A showing details including glide rail, lock plate, piano hinge and side view of a front panel with handle, according to an embodiment of the present invention;

FIG. 3B is a front cross-sectional view of the exemplary sliding and stacking portable pet ramp of FIG. 1A showing details including four floor panel members stacked in a box housing, and depicting a toe kick and front cross sectional view of ball bearing slides of the pet ramp, according to an embodiment of the present invention;

FIG. 4A is a magnified left-side cross-sectional view of a fourth bottom floor panel member of the exemplary sliding and stacking portable pet ramp of FIG. 1A showing a connection arrangement of aft and forward sections of the fourth floor panel member, according to an embodiment of the present invention;

FIG. 4B is a side view of the exemplary sliding and stacking portable pet ramp of FIGS. 1A and 2 showing the ramp in a fully-extended position with the housing placed at an elevated surface, and with floor panel members fully extended, unstacked and declined to form a ramp, according to an embodiment of the present invention;

FIG. 5 is a magnified aerial view of the fourth floor panel member of the exemplary portable pet ramp shown in FIG. 4A, showing further details of a connection arrangement between the aft and forward sections of the fourth floor panel member, according to an embodiment of the present invention;

FIG. 6 is a magnified aerial view of at least a portion of the exemplary sliding and stacking portable pet ramp of FIG. 2 showing two adjacent floor panel members, fully extended and unstacked, joined together with a sliding mechanism, according to an embodiment of the present invention; and

FIGS. 7A and 7B are magnified side views of at least a portion of the exemplary sliding and stacking portable pet ramp of FIG. 2 showing an illustrative pivotal connection arrangement between a first floor panel member of the ramp and a front panel of the housing, with the front panel configured in a closed position and an open position, respectively, according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

Principles of the present disclosure will be described herein in the context of an illustrative pet ramp which is portable, compact, adjustable to infinite combinations of lengths (up to a maximum overall length of the ramp) and angles of incline, among other features. It is to be appreciated, however, that the specific apparatus and/or methods illustratively shown and described herein are to be considered exemplary as opposed to limiting. Additionally, while an application of the portable ramp is described herein primarily with reference to facilitating pet/animal locomotion between different surface elevations, the portable ramp according to aspects of the invention may be used with other applications, such as, for example, transporting recreational vehicles, lawn maintenance equipment and other light-duty work equipment, etc. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

In the following description, certain specific details are set forth in order to provide a more thorough understanding of various aspects of the disclosed subject matter. However, it is to be appreciated that one or more embodiments of the disclosed subject matter may be practiced without all these specific details. In some instances, well-known apparatus and/or methods comprising embodiments of the subject matter disclosed herein have not been described in detail to avoid obscuring the descriptions of other aspects of the present disclosure.

Unless the context requires otherwise, throughout the specification and appended claims, the word “comprise” and variations thereof, such as “comprises” and “comprising,” are to be construed in an open, inclusive sense; that is, as “including, but not limited to.”

Reference throughout the specification to “one embodiment” or “an embodiment” is intended to imply that a particular feature, structure, or characteristic described in connection with the embodiment is included in at least one embodiment. Thus, the appearance of the phrases “in one embodiment” or “in an embodiment” in various places throughout the specification are not necessarily all referring to the same aspect. Moreover, the particular features, structures, and/or characteristics may be combined in any suitable manner in one or more aspects of the present disclosure.

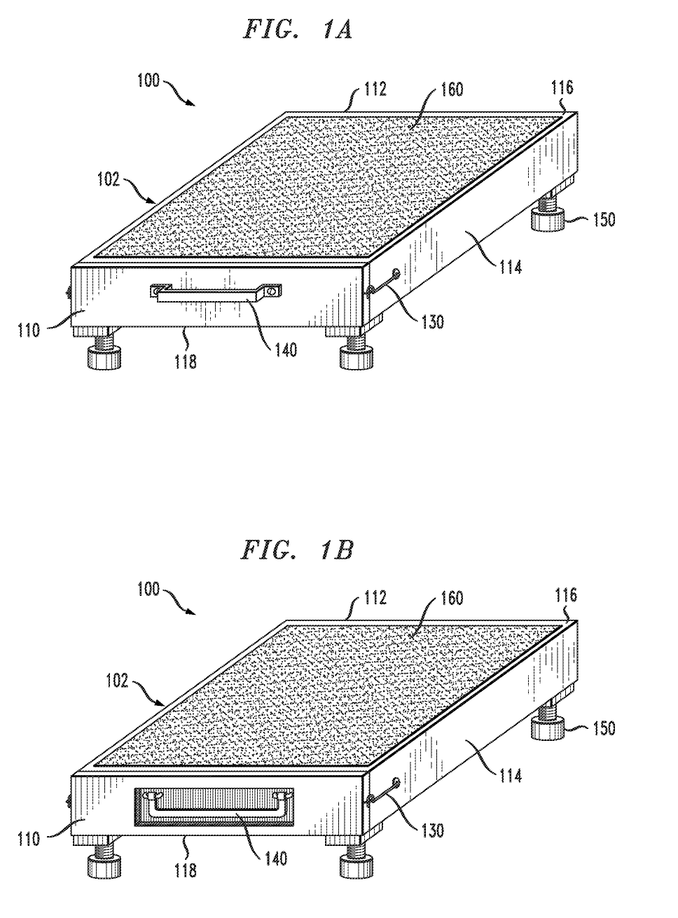

FIG. 1A is a perspective view of an exemplary portable box ramp 100, suitable for use in transporting animals or vehicles/equipment, with sliding and stacking surfaces shown in a closed, compact form, according to an embodiment of the present invention. The exemplary ramp 100 includes a housing 102 which, in this embodiment, is substantially rigid and shaped as a rectangular cuboid. Specifically, the housing 102 comprises a front panel 110, a rear panel 112, two opposing vertical sidewall panels 114, a top (dorsal) panel 116, and a bottom (ventral) panel 118. The top and bottom panels 116 and 118, respectively, are substantially parallel to one another and are in a plane perpendicular to the front, rear and sidewall panels 110, 112 and 114, respectively. The front and rear panels, 110 and 112, respectively, are parallel to one another, and the two sidewall panels 114 are parallel to one another and perpendicular to the front and rear panels. The respective panels 110, 112, 114, 116 and 118 are joined together as a box to define an interior space therebetween which retains sliding components of the pet ramp, as will be described in further detail below.

An exterior surface 160 of the top panel 116, in one or more embodiments, is preferably lined or otherwise covered with a slip-resistant (i.e., non-slip) material, such as, for example, carpet, rubber, cork, polyurethane foam, grit tape, etc., to provide enhanced traction for the pet while walking up or down the ramp 100. The non-slip material may be secured to the top panel 116 using essentially any known attachment means, including, but not limited to, adhesive, screws, clamps, etc. In other embodiments, the top panel 116 may be pre-formed having a non-slip exterior surface, such as by cutting ridges or grooves into the surface, or by coating the exterior surface 160 of the top panel 116 (e.g., spray coating, deposition technique, etc.). Various other means for providing a non-slip surface for the pet ramp 100 are contemplated, as will become apparent to those skilled in the art.

In one or more embodiments, the pet ramp 100 includes a plurality of legs 150 supporting the housing 102. In the illustrative embodiment shown, four legs are employed. It is to be appreciated, however, that embodiments of the invention are not limited to four legs; that is, a lesser number (e.g., three) or a great number (e.g., six) of legs may be utilized. The legs 150 are preferably fastened to the bottom panel 118 of the housing 102 using a variety of contemplated attachment means, including, but not limited to, screws, bolts, adhesive, etc. Optionally, one or more of the legs 150 are adjustable in height (e.g., by turning the leg on a threaded base mount) to thereby enable the housing 102 to be substantially leveled, even when the pet ramp 100 is placed on an uneven surface. In one or more embodiments, the legs, or at least a portion of the legs, are formed so as to prevent sliding of the pet ramp 100 when placed on an exterior surface. For example, the legs 150 may be made having rubber tips, or manufactured of metal having a pointed end which contacts the exterior surface (e.g., metal spikes).

In one or more embodiments, the front panel 110 is removably fastened to the housing 102. When the front panel 110 is removed, the sliding components of the pet ramp 100 are accessible for extension of the ramp as desired. Preferably, in one or more embodiments, the housing 102 includes one or more fastening devices 130 by which the front panel can be secured to the rest of the housing (e.g., one or more of the sidewall panels 114, top panel 116 and bottom panel 118). In the illustrative embodiment shown in FIG. 1A, a simple hook-and-eye latch 130 is employed, with a first component (e.g., an eye screw) of the latch fastened to the front panel 110 and a second component (e.g., hook screw) fastened to an adjacent panel of the housing 102, such as a sidewall panel 114. For added security, two or more fastening devices 130 may be used; for example, one fastening device securing the front panel 110 to a first one of the sidewall panels 114, and another fastening device securing the front panel to a second one of the sidewall panels, as shown. It is to be appreciated that other styles of fastening devices, such as, for example, a mortise lock, key-operated lock, butterfly latch, etc., may be used to secure the front panel 110 to one or more adjacent panels of the housing 102. While the front panel 110 is fastened in its closed position (as depicted in FIG. 1A), the sliding components of the pet ramp 100 remain secured within an interior of the housing 102.

The pet ramp 100, in one or more embodiments, includes a handle 140 or similar carrying mechanism attached to at least one of the panels, preferably the front panel 110. In this manner, when the front panel 110 is closed and fastened (i.e., locked) using the fastening devices 130, the pet ramp 100 can be carried like a briefcase using the handle 140; this is considered a portable mode of operation of the pet ramp 100, as opposed to a normal mode of operation wherein the ramp is extended for use in facilitating animal (or vehicle/equipment, in one or more embodiments) movement. Moreover, when the fastening devices 130 are unfastened (i.e., unlocked) and the ramp 100 is being set up for normal operation, the handle 140 may be used to pull out or otherwise extend the sliding components of the ramp 100, which in one or more embodiments are attached to the front panel 110.

In one or more embodiments, the handle 140 is recessed at least partially within the front panel 110, or whatever panel of the housing the handle is attached to, so that it is flush with the front panel when not in use, as shown in FIG. 1B. Alternatively, in one or more embodiments, a swing-type handle may be used which rests flat against the front panel when not being pulled by an operator of the ramp. Having a recessed or swing-type handle beneficially allows the front panel 110 of the ramp 100 to lie flat on the surface upon which it is placed.

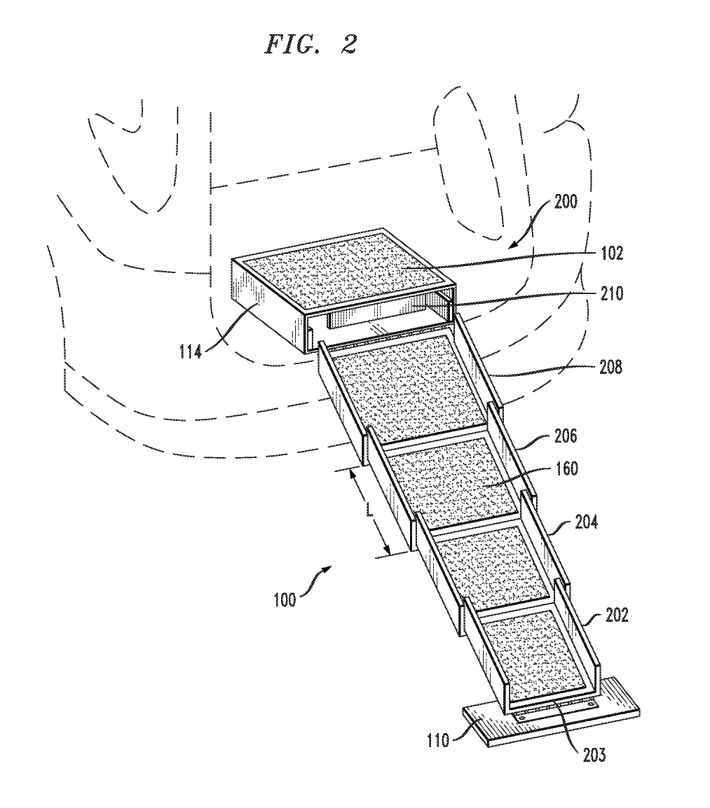

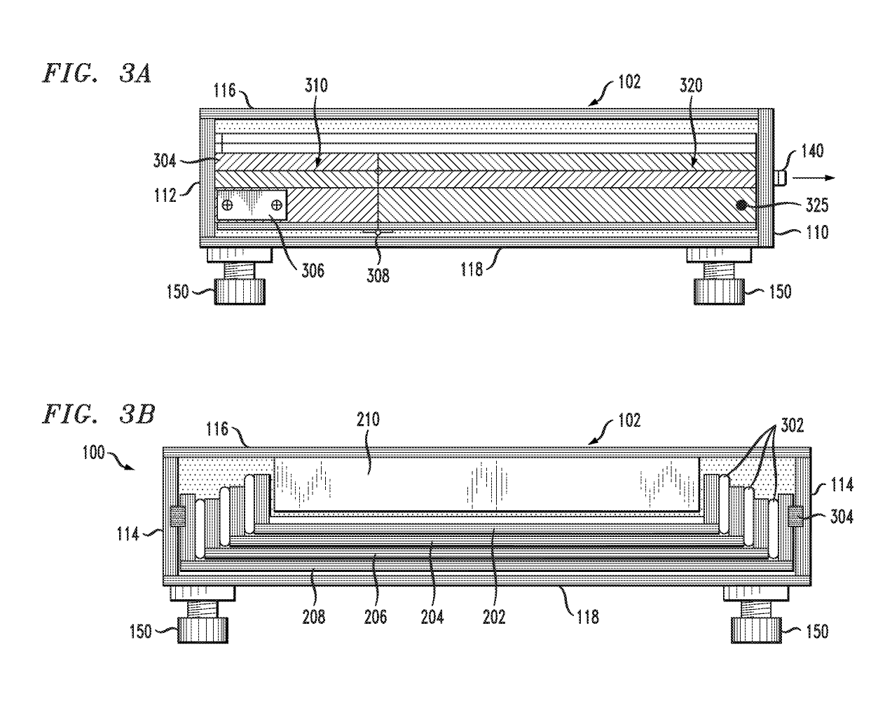

FIG. 2 is a perspective aerial view of the exemplary portable box pet ramp 100 shown in FIG. 1A configured in an extended position, according to an embodiment of the present invention. By way of example only and without limitation, the pet ramp 100 is shown operated from an elevated surface; in this scenario, from the floor of the back of a vehicle 200. The pet ramp 100 is depicted with its internal sliding components fully extended. As will be described in further detail below, the box housing 102 of the pet ramp 100 is configured to enclose a set of four floor panel members stacked on top of one another in a nested arrangement (detailed in FIG. 3B). Each floor panel member, in this embodiment, is formed having opposing vertical sidewalls substantially perpendicular (i.e., at about ninety degrees) to a floor (i.e., bottom wall) portion thereof; the vertical sidewalls and floor of each floor panel member, together, form a substantially U-shaped structure.

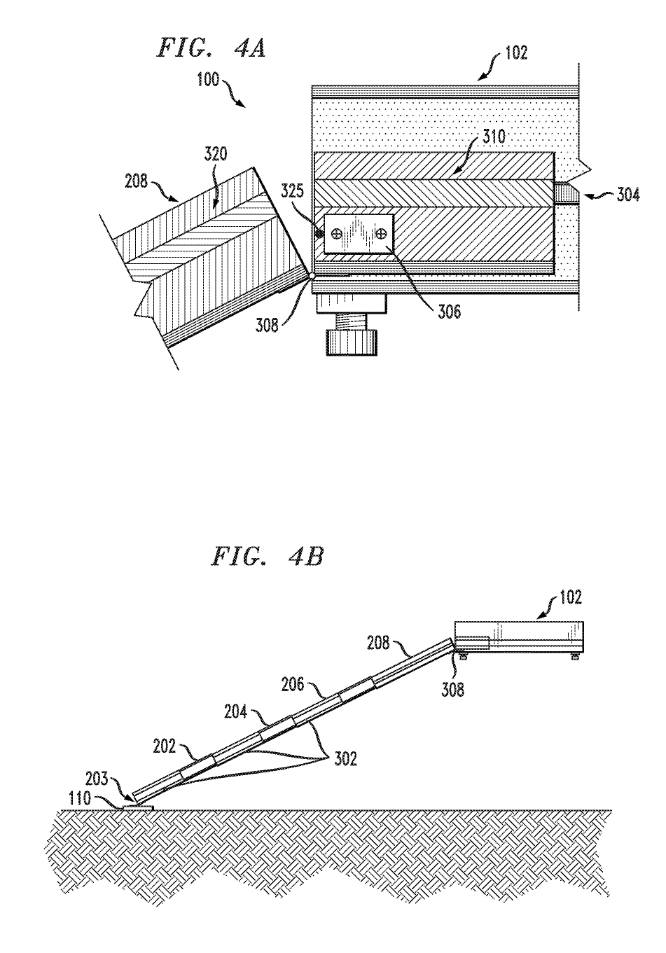

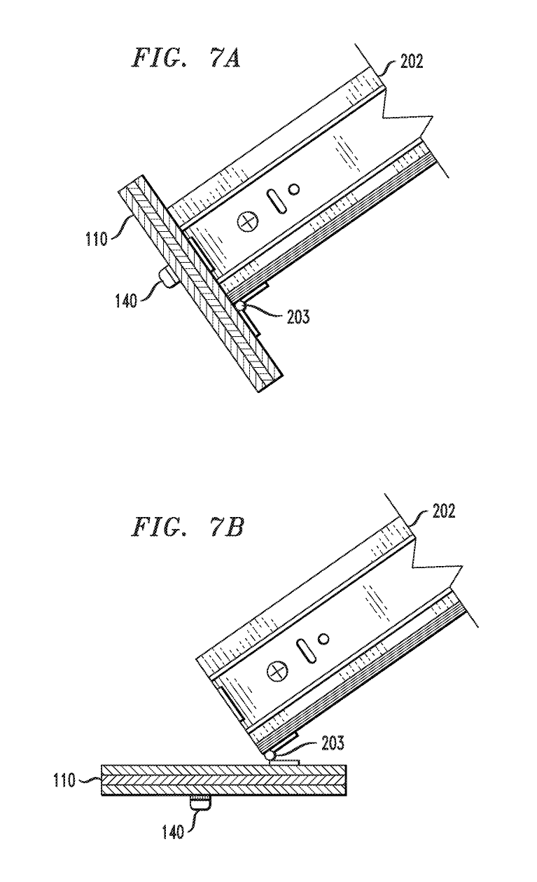

Specifically, the illustrative ramp 100 includes a first floor panel member 202, which is pivotally attached at a first (leading) end to the front panel 110 (e.g., using a first hinge 203—a piano hinge or the like, shown in further detail in FIGS. 7A and 7B), a second floor panel member 204, which is slidably attached at a first end to a second end, opposite the first end, of the first floor panel member, a third floor panel member 206, which is slidably attached at a first end to a second end, opposite the first end, of the second floor panel member, and a fourth (last) floor panel member 208, which is slidably attached at a first end to a second end, opposite the first end, of the third floor panel member and is pivotally attached at a second end, opposite the first end, to the bottom panel 118 of the housing 102 (e.g., using a second hinge 308—a piano hinge or the like, as shown in further detail in FIG. 4A).

Although four floor panel members 202, 204, 206 and 208 are shown in this illustrative embodiment, it is to be understood that a fewer number (e.g., three) or greater number (e.g., five) of floor panel members may be used, as will become apparent to those skilled in the art given the teachings herein. For example, to increase a maximum overall length of the ramp 100 (when fully extended), more floor panel members can be used without increasing the length of each individual floor panel member. Consequently, a length of the housing 102, which encloses the floor panel members when the ramp 100 is retracted, need not be increased, which is an advantage for enhanced portability. Additionally, various widths and lengths of each of the floor panel members are contemplated; that is, embodiments of the invention are not limited to any specific dimensions of the floor panel members. In an exemplary embodiment, a length, L, of each floor panel member is about 24 inches, and a width of the widest floor panel member (e.g., the fourth floor panel member 208) is about 24 inches. The respective widths of the floor panel members will be different, since a given floor panel member, beginning with the first floor panel member 202, is preferably designed to retract in a nested configuration within a width of an adjacent floor panel member. Thus, the first floor panel member 202 will have the smallest width, while the fourth (last) floor panel member 208 will have the largest width, as shown in FIG. 2.

More particularly, in the embodiment shown, opposing sidewalls of the first floor panel member 202 are narrower in width relative to an interior of the second floor panel member 204, so that when retracted, the first floor panel member can slide between sidewalls of the second floor panel member. Likewise, the second floor panel member 204 is narrower in width than the third floor panel member 206, so that when retracted, the second floor panel member can slide between sidewalls of the third floor panel member. Similarly, the third floor panel member 206 is narrower in width than the fourth floor panel member 208, so that when retracted, the third floor panel member can slide between sidewalls of the fourth floor panel member. And finally, the fourth floor panel member 208 is narrower than a width of the housing 102, so that the last (fourth) floor panel member (containing all of the other floor panel members nested therein) can retract fully between the sidewall panels 114 of the housing 102.

The floor panel members 202, 204, 206, 208 are, in one or more embodiments, formed of a lightweight material that is structurally rigid enough to support the weight of an animal or vehicle for which the ramp is designed to be used. Suitable materials which may be used to fabricate the floor panel members include, but are not limited to, wood, metal (e.g., aluminum), plastic, hard rubber, etc., or combinations of one or more of these materials. Preferably, the floor panel members are comprised of materials having a high rigidity/support-to-weight ratio. The vertical sidewalls and floor panel of each of the floor panel members may be formed separately and subsequently joined together (e.g., using fasteners, adhesive or the like), or the sidewalls and floor panel may be formed as a single homogeneous U-shaped structure (e.g., cast aluminum or an injection-molded plastic or rubber floor panel member).

Preferably, in one or more embodiments, an upper surface 160 of each of the floor panel members 202, 204, 206 and 208 (i.e., the surface on which an animal or vehicle touches while using the ramp 100), includes a cushioning and slip-resistant material or coating, similar to the upper surface of the top panel 116 of the housing 102, to thereby provide comfort and traction for an animal. Materials suitable for use with aspects of the invention include, but are not limited to, carpeting, rubber, cork, polyethylene foam, grit tape/strips, etc., which may be affixed to the respective floor panel members using any known attachment means, such as, for example, adhesive, fasteners (e.g., screws or bolts/nuts), clamps and the like. Alternatively, each of the floor panel members may be prefabricated having a textured/slip-resistant surface, such as, for example, grooves or other patterns cut, etched or stamped into the floor panel members.

Optionally, a front opening of the box housing 102, visible when the front panel 110 has been removed, has a blocking strip 210 affixed to an underside surface of the top panel 116 which functions as a toe kick to prevent injury to the foot of an animal when climbing up the ramp 100. The blocking strip 210, in one or more embodiments, is substantially rectangular in shape and is adapted to cover most of the front opening and yet still allow the sliding floor panel members to pass and fully retract within the housing 102 without obstruction. The blocking strip 210, which may be formed of essentially any rigid or semi-rigid material (e.g., wood, plastic, metal, rubber, etc.), may be affixed to the underside surface of the top panel 116 using various attachment means, including, but not limited to, adhesive, fasteners (e.g., screws or bolts/nuts), etc., as will be known by those skilled in the art.

FIGS. 3A and 3B depict details of an exemplary sliding arrangement of the floor panel members 202, 204, 206, 208 of the ramp 100, in accordance with an embodiment of the invention; FIG. 3A is a side cross-sectional view of the exemplary ramp 100 of FIG. 1A showing details including a glide rail 304, lock plate 306 or other locking mechanism, and hinge 308, according to an embodiment of the invention; FIG. 3B is a front cross-sectional view of the exemplary ramp 100 of FIG. 1A showing an arrangement of the four floor panel members 202, 204, 206, 208 stacked in the housing 102, including slide mechanisms 302.

As apparent from FIGS. 3A and 3B, which show the ramp 100 with the right sidewall panel 114 and front panel 110, respectively, removed from the housing 102, in one or more embodiments external surfaces of the opposing vertical sidewalls of each of the floor panel members 202, 204, 206, 208 include slide mechanisms 302, preferably ball bearing slides or the like, attached thereto. A first portion of the slide mechanism affixed to the vertical sidewall of one floor panel member is adapted to engage with a second (mating) portion of the slide mechanism affixed to the vertical sidewall of an adjacent floor panel member, so that the adjacent floor panel members are slidably engaged with one another. In one more embodiments, the first portion of the slide mechanism 302 may comprise, for example, a nylon/plastic or metal roller or bearing (shown more clearly in FIG. 3B), and the second portion of the slide mechanism may comprise a metal guide rail 304 (shown more clearly in FIG. 3A) adapted to receive the roller or bearing of the first portion of the slide mechanism. Alternatively, in one or more embodiments, the slide mechanism 302 may be implemented as a guide rail (not explicitly shown in the figure, but implied as reference numeral 302) formed on or otherwise attached to a vertical sidewall of a given floor panel member which protrudes from the sidewall and is adapted to fit into, and is received by, a corresponding channel or slot cut into the vertical sidewall of an adjacent floor panel member, without the use of additional hardware (e.g., ball bearings, rollers, etc.). The slide mechanisms 302 allow the floor panel members to easily slide into and out of the box housing 102, much like a drawer, and permit all floor panel members to stack back on top of one another when the ramp is retracted and enclosed within the housing. As shown in FIG. 3B, the blocking strip 210 substantially covers the front opening and yet still allows the floor panel members 202, 204, 206, 208 to slide underneath without interference.

When the floor panel members 202, 204, 206, 208 are slid out of the box housing 102 and are fully extended, they preferably lock into place, preventing any further lateral movement (e.g., sliding) of the floor panel members relative to one another, to thereby form a rigid ramp. Depending on the application in which the ramp is being used, the required length and slope, among other factors, the ramp may not need to be fully extended. In this instance, the floor panel members will overlap one another, with the overlapping amount of each floor panel member onto an adjacent floor panel member being a function of the required overall length of the ramp. For example, if only half of the maximum overall length of the ramp is required, each of the floor panel members can overlap one another by about half of its length, in one or more embodiments. If a length of about 75 percent of the maximum overall length of the ramp is needed, each floor panel member may overlap an adjacent floor panel member by about 25 percent of its length, in one or more embodiments. The amount of overlap of one floor panel member on an adjacent floor panel member need not be the same as the overlap associated with the other floor panel members forming the overall ramp. Rather, the overlap of each of the floor panel members on a corresponding adjacent floor panel member can be adjusted in various combinations so that, collectively, a ramp of a desired overall length (up to the maximum length) is achieved.

In one or more embodiments, the front panel 110 of the box housing 102 is pivotally attached to a leading edge of the first floor panel member 202 with a piano hinge (203 in FIG. 2) or the like, as previously stated. Pulling the handle 140 on the front panel 110 allows the first floor panel member 202, which is attached to the front panel, to slide out of the housing 102, using its corresponding slide mechanism 302. Once the first floor panel member 202 is extended out of the housing, the second floor panel member 204, stacked below the first floor panel member 202, begins to slide out of the housing 102, followed by the third floor panel member 206, followed by the fourth floor panel member 208, respectively.

In one or more embodiments, the last (fourth) floor panel member 208 comprises two sections (i.e., portions)—namely, an aft (i.e., back) section 310 and a forward (i.e., front) section 320—attached to each other by hinge 308 (e.g., a piano hinge, in one or more embodiments). The aft section 310 of the fourth floor panel member 208 moves on glides 304 and the forward section 320 moves on ball bearing slides 302 affixed to the vertical sidewalls of the fourth floor panel member 208. The aft section 310 remains in the housing 102 while the forward section 320 slides out of the housing when the ramp is extended. The hinge 308 allows the ramp, once extended (at least partially) from the housing 102, to be placed at any angle relative to the ground to provide the desired slope for the animal or vehicle to ascend or descend the ramp. This hinge 308 also prevents the housing 102 from tilting upwards when the ramp 100 is fully extended.

In order to prevent the aft section 310 of the fourth floor panel member 208 from becoming completely detached from the housing 102, the ramp 100 includes one or more locking mechanisms 306 (two locking mechanisms in this exemplary embodiment), each locking mechanism being affixed to an exterior surface of vertical sidewalls of the aft section 310 of the fourth floor panel member 208. When the fourth floor panel member 208 extends out of the housing 102 beyond a prescribed amount, the locking mechanisms 306 slide forward and engage with screws, posts or similar stopping structures 325, attached to corresponding sidewall panels 114 of the housing 102 to thereby prevent the aft section 310 of the fourth floor panel member 208 from falling out of the housing.

FIG. 4A is a magnified left-side cross-sectional view of the fourth floor panel member 208 of the exemplary sliding and stacking portable ramp 100 of FIG. 1A, showing the exemplary connection arrangement of the aft and forward sections, 310 and 320, respectively, according to an embodiment of the invention. The forward section 320 of the fourth floor panel member 208 slides completely out of the housing 102, pivoting at the hinge 308 which connects the aft and forward sections together, and the aft section 310 remains in the housing 102 as a result of the locking mechanism 306 engaging with the corresponding stopping structure 325, as shown in FIG. 4A.

FIG. 4B is a side view of the exemplary ramp 100 of FIGS. 1A and 2 showing the ramp in its fully extended position, with the housing 102 placed at an elevated surface and with the floor panel members 202, 204, 206 and 208 fully extended, unstacked and sloped downward to form a ramp, according to an embodiment of the invention. Once the ramp 100 is fully extended, the front panel 110 of the housing 102, which is attached to the first floor panel member 202 via the hinge 203, is tilted forward and downward at the hinge 203 and is placed on a lower or ground surface (relative to the housing 102), as depicted in FIG. 4B. This provides a firm grip on the surface and prevents the ramp 100 from sliding and stacking backwards. The downward tilting of the front panel 110 also provides the pet an easy, obstacle-free access to the ramp 100.

As previously stated, once the ramp 100 is fully extended, the floor panel members 202, 204, 206, 208 preferably lock into place, in one or more embodiments, to prevent further lateral movement (i.e., sliding) of the floor panel members relative to one another and thereby provide a rigid ramp. It is to be understood that in some embodiments, not all floor panel members may be locked into place during normal use, but rather one or more floor panel members may remain unlocked to provide essentially unlimited combinations of lengths of the ramp 100. In one or more embodiments, although the floor panel members may be locked into place, the aft section 310 of the last (fourth) floor panel member 208 remains free to slide back and forth within the housing 102 along its corresponding glide rail 304, or other slide mechanism. This allows a user to make minor adjustments to the length of the ramp as necessary even when all floor panel members are locked in a fixed position.

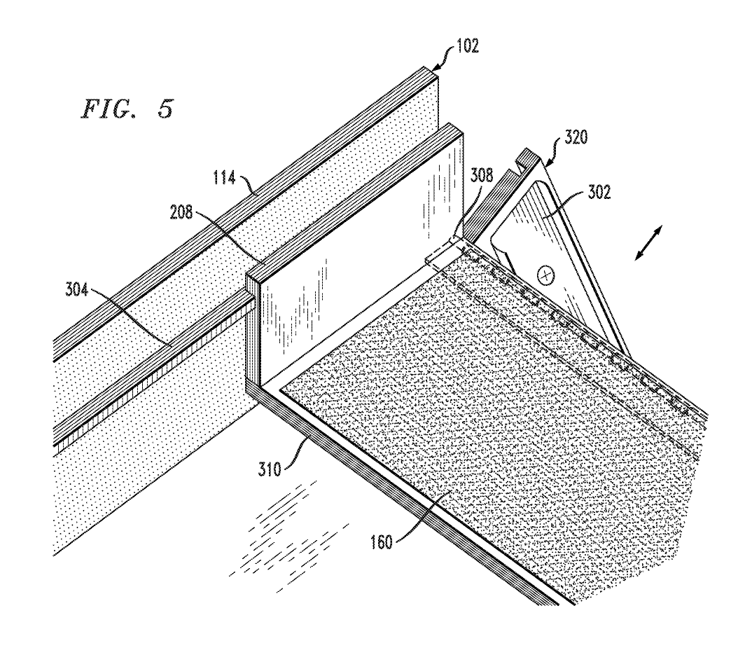

FIG. 5 is a magnified aerial view at least a portion of the fourth floor panel member 208 of the illustrative portable pet ramp 100 shown in FIG. 4A, showing further details of the connection arrangement between the aft 310 and front 320 sections of the fourth floor panel member, according to an embodiment of the invention. As previously described in conjunction with FIGS. 4A and 4B, the forward section 320 of the fourth floor panel member 208 extends outside the front opening of the housing 102 and slopes toward the direction of the front panel 110 (not explicitly shown in FIG. 5), downward in this scenario, so that the hinge 308 joining the aft and forward sections of the fourth floor panel member is substantially flush with a leading edge of the front opening of the housing 102. The aft section 310 of the fourth floor panel member 208 remains within the housing 102, being held from sliding completely out of the housing by the locking mechanism 306 engaging with the corresponding stopping structure 325, as previously explained in connection with FIG. 4A.

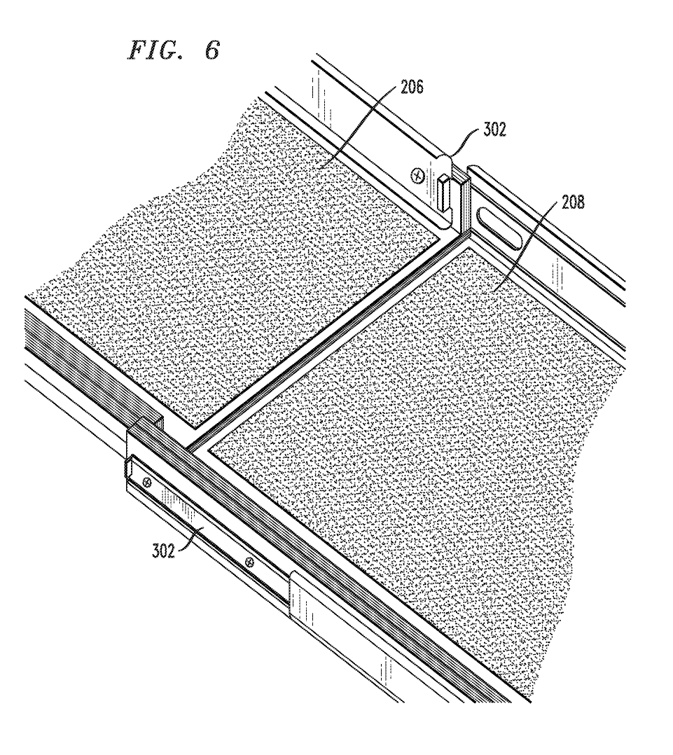

With reference now to FIG. 6, a magnified aerial view depicts at least a portion of the exemplary portable pet ramp 100, illustrating two adjacent floor panel members, 206 and 208, fully extended and unstacked, according to an embodiment of the invention. As previously described, the adjacent floor panel members 206, 208 are slidably attached together using slide mechanisms 302, whereby portions of the slide mechanisms 302 attached to the vertical sidewalls of one floor panel member (e.g., 206) are engaged with receiving portions of the slide mechanisms 302 attached to the vertical sidewalls of the adjacent floor panel member (e.g., 208), so that one floor panel member 206 overlaps the adjacent floor panel member 208, the amount of overlap of one floor panel member on the adjacent floor panel member being adjustable as a function of the extended length of the ramp sections. As shown in FIG. 6, even when fully extended, an end of one floor panel member (e.g., 206) preferably overlaps an end of an adjacent floor panel member (e.g., 208) so that there is no gap between the adjacent floor panel members; this overlap also provides additional support for the ramp, particularly at attachment points between the adjacent floor panel members. Optionally, in one or more embodiments, when fully extended, the slide mechanisms 302 may include a stop mechanism or lock, so as to prevent the adjacent floor panel members 206, 208 from detaching from one another.

FIGS. 7A and 7B are magnified side views of at least a portion of the exemplary sliding and stacking portable pet ramp 100 of FIG. 2 showing an illustrative hinged connection arrangement between the first floor panel member 202 and the front panel 110, with the front panel configured in a closed position and an open position, respectively, according to an embodiment of the invention. In one or more embodiments, the pivotal connection between the first floor panel member 202 and the front panel 110 is implemented using hinge 203, which is preferably a piano hinge or the like, although various other hinged or pivotal connection arrangements are similarly contemplated, such as, for example, a ball-and-socket joint. As previously stated, the hinged connection arrangement of the front panel 110 with the first floor panel member 202 enables the front panel to be placed parallel with the ground or other surface and allow for adjustment of the ramp angle. Furthermore, the hinged arrangement provides an unobstructed access to the ramp by an animal.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. An apparatus for facilitating animal or vehicle movement between different surface elevations, the apparatus comprising:
a plurality of floor panel members including at least a first floor panel member and a last floor panel member, each of the floor panel members being slidably attached to an adjacent one of the floor panel members, the plurality of floor panel members, when extended, forming a ramp having a length which is variable up to maximum overall length of the apparatus, the floor panel members being adapted to nest within one another when retracted; and
a housing having an interior space configured to enclose the plurality of floor panel members when the floor panel members are retracted, the last floor panel member being operatively coupled to the housing in a manner which enables the ramp to be slidably removed through a front opening of the housing without having the last floor panel member disengage from the housing, the last floor panel member being configured to provide an adjustable angle of the ramp in relation to the front opening of the housing, the housing comprising a front panel removably attached to the housing and pivotally attached to the first floor panel member, the front panel facilitating extension of the plurality of floor panel members to form the ramp, the front panel being configured to secure the plurality of floor panel members within the interior space of the housing when the ramp is retracted.

2. The apparatus of claim 1, further comprising a blocking strip affixed to an underside surface of a top panel of the housing, the blocking strip being adapted to substantially cover the front opening of the housing and yet allow the plurality of floor panel members to slide under the blocking strip without obstruction when the ramp is retracted within the housing.

3. The apparatus of claim 1, further comprising a hinge attaching the front panel of the housing to the first floor panel member.

4. The apparatus of claim 1, wherein the housing comprises a top panel having at least a portion of an exterior surface thereof covered with a slip-resistant material for providing traction for the animal while walking on the ramp.

5. The apparatus of claim 4, wherein the slip-resistant material comprises at least one of carpeting, rubber, cork, polyurethane foam and grit tape.

6. The apparatus of claim 1, wherein each of the plurality of floor panel members comprises a floor panel and two sidewalls extending vertically from the floor panel to form a U-shaped structure, the floor panel having at least a portion of an exterior surface thereof covered with a slip-resistant material for providing traction for the animal while walking on the ramp.

7. The apparatus of claim 6, further comprising a plurality of slide mechanisms, a first portion of a given one of the slide mechanisms being affixed to the vertical sidewall of one of the floor panel members and adapted to engage with a second portion of the given one of the slide mechanisms affixed to the vertical sidewall of an adjacent one of the floor panel members, so that adjacent floor panel members are slidably attached to one another.

8. The apparatus of claim 7, wherein each of the slide mechanisms is adapted to lock into a fixed position when adjacent floor panel members are extended to form the ramp.

9. The apparatus of claim 7, wherein each of at least a subset of the slide mechanisms comprises at least one of: a ball bearing slide; and a guide rail and corresponding channel adapted to receive the guide rail.

10. The apparatus of claim 1, wherein the housing comprises at least a top panel, a bottom panel and two sidewall panels, the two sidewall panels being parallel to one another and perpendicular to the top and bottom panels, the apparatus further comprising at least one fastening device, the fastening device being configured to removably attach the front panel to one of the top, bottom and sidewall panels to thereby secure the front panel to the housing.

11. The apparatus of claim 10, further comprising a handle, the handle being affixed to at least one of the top, bottom and sidewall panels of the housing.

12. The apparatus of claim 11, wherein the handle is recessed within a panel of the housing to which it is attached at least when the handle is not in use.

13. The apparatus of claim 1, further comprising a plurality of legs supporting the housing, each of the legs being fastened to a bottom panel of the housing.

14. The apparatus of claim 13, wherein at least one of the plurality of legs has an adjustable height.

15. The apparatus of claim 1, wherein the last floor panel member comprises an aft section and a forward section pivotally attached to one another, the last floor panel member being configured such that the aft section remains within the housing while the forward section slides out of the housing when the ramp is extended, the forward section being angled relative to the aft section when the ramp is extended, an angle between the forward and aft sections being a function of an angle of the ramp relative to a surface on which the first floor panel member is placed.

16. The apparatus of claim 15, further comprising a hinge attached to the aft and forward sections of the last floor panel member, the hinge allowing the forward section of the last floor panel member to be angled relative to the aft section.

17. The apparatus of claim 15, further comprising at least one locking mechanism attached to a vertical sidewall of the forward section of the last floor panel member, the locking mechanism being configured to slide along a sidewall panel of the housing and to engage with a corresponding stopping structure attached to said sidewall panel of the housing to thereby prevent the aft section of the last floor panel member from being detached from the housing.

18. The apparatus of claim 15, wherein each of the floor panel members is adapted to lock into a fixed position with an adjacent floor panel member when the floor panel members are extended to form the ramp, and wherein when all floor panel members are locked into a fixed position, the aft section remains free to slide back and forth within the housing to thereby enable a user to make adjustments to a length of the ramp.

19. The apparatus of claim 1, wherein each of at least a subset of the floor panel members is comprised of at least one of wood, plastic and rubber configured to support the weight of an animal or vehicle utilizing the apparatus.

20. The apparatus of claim 1, wherein each of at least a subset of the plurality of floor panel members comprises a floor and two sidewalls extending vertically from the floor, the floor and sidewalls of the floor panel member being formed as a single, homogeneous U-shaped structure.

21. The apparatus of claim 1, wherein each of the plurality of floor panel members is configured to overlap an adjacent one of the floor panel members by a prescribed amount, the prescribed amount of overlap being a function of at least one of a length and an angle of incline of the ramp.

22. A method of facilitating animal or vehicle movement between different surface elevations, the method comprising:
obtaining a sliding and stacking portable ramp, the portable ramp comprising:
a plurality of floor panel members including at least a first floor panel member and a last floor panel member, each of the floor panel members being slidably attached to an adjacent one of the floor panel members, the plurality of floor panel members, when extended, forming a ramp having a length which is variable up to maximum overall length of the apparatus, the floor panel members being adapted to nest within one another when retracted; and
a housing having an interior space configured to enclose the plurality of floor panel members when the floor panel members are retracted, the last floor panel member being operatively coupled to the housing in a manner which enables the ramp to be slidably removed through a front opening of the housing without having the last floor panel member disengage from the housing, the last floor panel member being configured to provide an adjustable angle of the ramp in relation to the front opening of the housing, the housing comprising a front panel removably attached to the housing and pivotally attached to the first floor panel member, the front panel facilitating extension of the plurality of floor panel members to form the ramp, the front panel being configured to secure the plurality of floor panel members within the interior space of the housing when the ramp is retracted; and
placing the portable ramp on a first surface, pulling the front panel of the housing to extend the plurality of floor panel members to thereby form the ramp, and placing the front panel on a second surface, the second surface being different in elevation relative to the first surface.
